(19) United States
(12) Patent Application Publication
(10) Pub. No.: US 2006/0200597 A1
(43) Pub. Date: Sep. 7, 2006

(54) Method, system, and apparatus for memory controller utilization of an AMB write FIFO to improve FBD memory channel efficiency

(76) Inventors: Bruce A. Christenson, Forest Grove, OR (US); Chitra Natarajan, Flushing, NY (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/073,285

(22) Filed: Mar. 3, 2005

(51) Int. Cl. G06F 3/00

(52) U.S. Cl. 710/57

(57) ABSTRACT

A memory controller to support fully buffered DIMMS by utilizing a write FIFO to switch from the default condition of a memory controller scheduling read requests out-of-order to scheduling write transactions from a write FIFO buffer for a predetermined set of conditions is discussed. For example, the predetermined set of conditions are a write buffer structure has exceeded a threshold (wherein the threshold is fixed or specified by a configuration register) and a memory controller has posted a predetermined number of writes to an AMB write FIFO structure (the predetermined number can be fixed or specified by a configuration register).

### BACKGROUND OF THE INVENTION

1. Field of the Invention

The present invention relates to memory controllers that support fully buffered DIMMS by utilizing a write FIFO to switch from the default condition of a memory controller scheduling read requests out-of-order to scheduling write transactions from a write FIFO buffer for a predetermined set of conditions.

2. Description of the Related Art

Typically, a memory controller that supports a fully buffered DIMM sends write data on a FBD channel just in time to be driven on a DRAM channel behind a FBD AMB. AMB is a buffer chip on the DIMM that interfaces the FBD channel signals to the DRAM device signals). Consequently, the data bus utilization on the DRAM channel is 50% because the FBD channel has half the write bandwidth of a DRAM channel.

### BRIEF DESCRIPTION OF THE SEVERAL VIEWS OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a method of a memory controller algorithm as utilized by one embodiment.

FIG. 2 is a system in accordance with one embodiment.

### DETAILED DESCRIPTION OF THE INVENTION

A system, apparatus, and method for improving efficiency of a memory channel are described. In the following description, for purposes of explanation, numerous details are set forth in order to provide a thorough understanding of the present invention. However, it will be apparent to one skilled in the art that these specific details are not required in order to practice the present invention.

An area of current technological development relates to improving transfer rates for memory subsystems. As previously described, a memory controller that supports a fully buffered DIMM by sending write data on a Fully Buffered Dimm (FBD) channel just in time to be driven on a DRAM channel behind a FBD AMB results in 50% data bus utilization on the DRAM channel because the FBD channel has half the write bandwidth of a DRAM channel.

In contrast, a method, apparatus, and system that facilitates memory controllers which support fully buffered DIMMS by utilizing a write FIFO to switch from the default condition of a memory controller scheduling read requests out-of-order to scheduling write transactions from a write FIFO buffer for a predetermined set of conditions is discussed. In one embodiment, the predetermined set of conditions is a write buffer structure that has exceeded a threshold (wherein the threshold is fixed or specified by a configuration register) and a memory controller has posted a predetermined number of writes to an AMB write FIFO structure (the predetermined number can be fixed or specified by a configuration register).

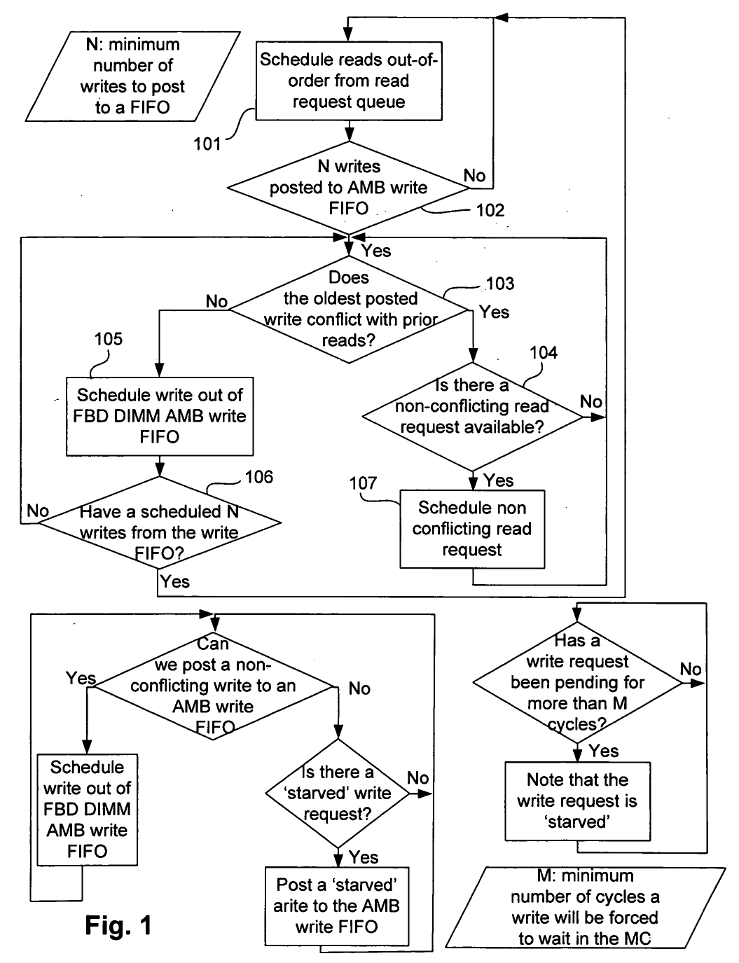

FIG. 1 is a method of a memory controller algorithm as utilized by one embodiment. As previously described, the memory controller for the claimed subject matter facilitates switching from the default condition of a memory controller scheduling read requests out-of-order to scheduling write transactions from a write FIFO buffer for a predetermined set of conditions is discussed. Once the memory controller has switched to scheduling write requests, it schedules the write requests that have been posted in a write FIFO structure in order. In one embodiment, the write FIFO structure is within a FBD AMB device, which is a buffer chip on a FBD DIMM. The memory controller returns to the default condition of scheduling read requests when the write FIFO structure is drained.

While the memory controller is in the non default operation of scheduling writes, it may be unable to schedule a write immediately due to a FBD or DRAM channel timing conflict. Consequently, the memory controller searches for a non-conflicting read request to schedule from a read request queue. If it finds a non-conflicting read request, the memory controller schedules it and returns to attempting to scheduling writes that have been posted to the AMB write FIFO.

The flowchart depicts searching for the previously described set of conditions to allow for scheduling the writes. For example, block 102 determines whether the memory controller has posted a predetermined minimum number of writes to an AMB write FIFO structure. If not, the default condition of scheduling reads out of order from read request queue continues, as depicted by a block 101.

Otherwise, the memory controller starts to schedule write. First, an analysis of whether an oldest posted write conflicts with prior reads is performed, as determined by a block 103. If so, an analysis of whether a non conflicting read request is available (as depicted by block 104), if so, scheduling a non conflicting read request, as depicted by block 107, and returning to block 103. Otherwise, scheduling a write out of the FBD DIMM AMB write FIFO is done, as depicted by block 105, and an analysis of whether there has been predetermined number of writes from the WRITE FIFO, as depicted by a block 106.

The remaining portion of the flowchart analyzes whether a write request has been pending for more than a certain number of cycles, if so, noting the write request is starved.

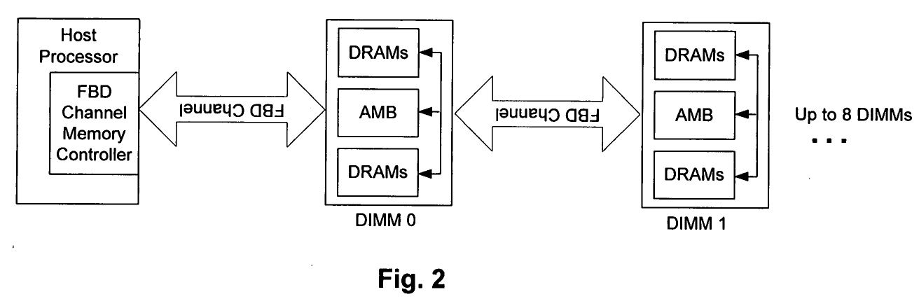

FIG. 2 is a system. as utilized by an embodiment. The system depicts a memory controller that supports FBD Dimms and a FBD channel to communicate with the DIMMs. As previously discussed, this system incorporates the previously discussed techniques for AMB WRITE FIFO TO IMPROVE FBD MEMORY CHANNEL EFFICIENCY.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A method for scheduling write transactions from a write buffer structure comprising:
scheduling write transactions from a write buffer structure when a write buffer structure has exceeded a threshold; and
posting a predetermined number of writes to an write FIFO structure.

2. The method of claim 1 wherein the threshold is fixed or specified by a configuration register.

3. The method of claim 1 wherein the predetermined number of writes can be fixed or specified by a configuration register.

4. A method for scheduling write transactions from a write buffer structure comprising:
switching from the default condition of a memory controller scheduling read requests out-of-order to scheduling write transactions from a write FIFO buffer for a predetermined set of conditions;
the predetermined set of conditions are:
scheduling write transactions from a write buffer structure when a write buffer structure has exceeded a threshold; and
posting a predetermined number of writes to an write FIFO structure.

5. The method of claim 4 wherein the threshold is fixed or specified by a configuration register.

6. The method of claim 4 wherein the predetermined number of writes can be fixed or specified by a configuration register.

7. A method for scheduling write transactions from a write buffer structure comprising:
switching from the default condition of a memory controller scheduling read requests out-of-order to scheduling write transactions from a write FIFO buffer for a predetermined set of conditions;
the predetermined set of conditions are:
scheduling write transactions from a write buffer structure when a write buffer structure has exceeded a threshold and posting a predetermined number of writes to an write FIFO structure.
once the memory controller has switched to scheduling write requests, scheduling the write requests that have been posted in the write FIFO structure in order; and
switching back to the default condition of scheduling read requests when the write FIFO structure is drained.

8. The method of claim 7 wherein the threshold is fixed or specified by a configuration register.

9. The method of claim 7 wherein the predetermined number of writes can be fixed or specified by a configuration register.

10. The method of claim 7 wherein the write FIFO structure is within a FBD AMB device, which is a buffer chip on a FBD DIMM.

11. A method for scheduling write transactions from a write buffer structure comprising:
switching from the default condition of a memory controller scheduling read requests out-of-order to scheduling write transactions from a write FIFO buffer for a predetermined set of conditions;
the predetermined set of conditions are:
scheduling write transactions from a write buffer structure when a write buffer structure has exceeded a threshold and posting a predetermined number of writes to an write FIFO structure.
once the memory controller has switched to scheduling write requests, scheduling the write requests that have been posted in the write FIFO structure in order;
searching for a non-conflicting read request to schedule from a read request queue if there is a timing conflict, if the non-conflicting read request is found, then scheduling the non-conflicting read request and then returning to attempt to scheduling writes that have been posted to the AMB write FIFO; and
switching back to the default condition of scheduling read requests when the write FIFO structure is drained.

12. The method of claim 11 wherein the threshold is fixed or specified by a configuration register

13. The method of claim 11 wherein the predetermined number of writes can be fixed or specified by a configuration register.

14. The method of claim 11 wherein the write FIFO structure is within a FBD AMB device, which is a buffer chip on a FBD DIMM.

15. A system comprising:
a processor, to request a memory access for a write transaction,
at least one fully buffered DIMM, coupled to the processor; and
a memory controller, coupled to the processor, to support the fully buffered DIMM and to scheduling write transactions for the DIMM from a write buffer structure when a write buffer structure has exceeded a threshold; and
posting a predetermined number of writes to an write FIFO structure.

16. The system of claim 11 wherein the write FIFO structure is within a FBD AMB device, which is a buffer chip on the FBD DIMM.

17. A system comprising:
a processor, to request a memory access for a write transaction,
at least one fully buffered DIMM, coupled to the processor; and
a memory controller, coupled to the processor, to support the fully buffered DIMM
to switch from a default condition of the memory controller scheduling read requests out-of-order to scheduling write transactions from a write FIFO buffer for a predetermined set of conditions;
the predetermined set of conditions are:
scheduling write transactions from a write buffer structure when a write buffer structure has exceeded a threshold; and
posting a predetermined number of writes to an write FIFO structure.

18. The system of claim 17 wherein the threshold is fixed or specified by a configuration register.

19. The system of claim 17 wherein the predetermined number of writes can be fixed or specified by a configuration register.

20. The system of claim 17 wherein the write FIFO structure is within a FBD AMB device, which is a buffer chip on the FBD DIMM.
